(19) United States
(12) Patent Application Publication
(10) Pub. No.: US 2026/0119707 A1
(43) Pub. Date: Apr. 30, 2026

(54) IMAGE FORMING SYSTEM, NON-TRANSITORY COMPUTER READABLE MEDIUM, AND IMAGE FORMING METHOD

(71) Applicant: FUJIFILM Business Innovation Corp., Tokyo (JP)

(72) Inventors: Akiyuki MAMIYA, Kanagawa (JP); Takashi Betsuyaku, Kanagawa (JP)

(73) Assignee: FUJIFILM Business Innovation Corp., Tokyo (JP)

(21) Appl. No.: 19/198,331

(22) Filed: May 5, 2025

(30) Foreign Application Priority Data
Oct. 29, 2024 (JP) 2024-189924

(51) Int. Cl. G06F 21/62; B02C 18/00; G06T 7/00

(52) U.S. Cl. CPC G06F 21/6245; B02C 18/0007; G06T 7/0004

(57) ABSTRACT

An image forming system includes: a printer for a continuous form; an inspection device that inspects a printed material output from the printer; and a processor configured to: cause a printed material output from the printer to be transported to the inspection device; in response to an anomaly being detected in the printed material in the inspection device, cause the printer to rewind the printed material with the detected anomaly; cause a leakage prevention process to be performed on the printed material in the printer, the leakage prevention process preventing information printed on the printed material from leaking outside; and cause the printed material on which the leakage prevention process is performed to be output again from the printer.

### CROSS-REFERENCE TO RELATED APPLICATIONS

This application is based on and claims priority under 35 USC 119 from Japanese Patent Application No. 2024-189924 filed Oct. 29, 2024.

### BACKGROUND

### (i) Technical Field

The present disclosure relates to an image forming system, a non-transitory computer readable medium, and an image forming method.

### (ii) Related Art

Japanese Unexamined Patent Application Publication No. 2005-028807 describes a printing processing apparatus that appropriately performs post-processing on even a medium, such as a paper sheet, including information to be concealed without leaking the information.

Japanese Unexamined Patent Application Publication No. 09-207416 describes a printing system capable of preventing poor printing or the occurrence of duplication or a defect of a printed material in performing high-speed printing of a large number of printed materials having mutually different contents.

Japanese Unexamined Patent Application Publication No. 09-240120 describes a printer that performs inspection for content consistency on front and back sides of respective printed materials and that removes a defective printed material.

### SUMMARY

In an image forming system including a continuous form printer and an inspection device that inspects a printed material output from a printer, the printed material output from the printer is inspected by the inspection device and thereafter is cut from a roll, and a printed material in which an anomaly is detected is discarded.

In this case, there is a possibility of leakage of information printed on the printed material, for example, because a worker sees or loses the printed material at the time of discarding the printed material.

Aspects of non-limiting embodiments of the present disclosure relate to providing an image forming system, a non-transitory computer readable medium, and an image forming method that are enabled to prevent leakage of information printed on a printed material printed with a continuous form printer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including: a printer for a continuous form; an inspection device that inspects a printed material output from the printer; and a processor configured to: cause a printed material output from the printer to be transported to the inspection device; in response to an anomaly being detected in the printed material in the inspection device, cause the printer to rewind the printed material with the detected anomaly; cause a leakage prevention process to be performed on the printed material in the printer, the leakage prevention process preventing information printed on the printed material from leaking outside; and cause the printed material on which the leakage prevention process is performed to be output again from the printer.

### BRIEF DESCRIPTION OF THE DRAWINGS

An exemplary embodiment of the present disclosure will be described in detail based on the following figures, wherein:

FIG. 1 is a diagram of the external appearance of an image forming system of an exemplary embodiment of the present disclosure;

FIG. 2 is a block diagram illustrating the hardware configuration of the image forming system;

FIG. 3 is a view illustrating an example printed material;

FIG. 4 is a view illustrating an example printed material on which a concealing process is performed;

FIG. 5 is a view illustrating an example printed material on which the concealing process is performed;

FIG. 6 is a view for explaining the concealing process serving as a leakage prevention process in the image forming system;

FIG. 7 is a view illustrating an example printed material on which instruction information is printed;

FIG. 8 is a view for explaining an instruction-information printing process serving as the leakage prevention process in the image forming system;

FIG. 9 is a view for explaining a correction process serving as the leakage prevention process in the image forming system; and

FIG. 10 is a flowchart for explaining the flow of an inspection process for a printed material in the image forming system.

### DETAILED DESCRIPTION

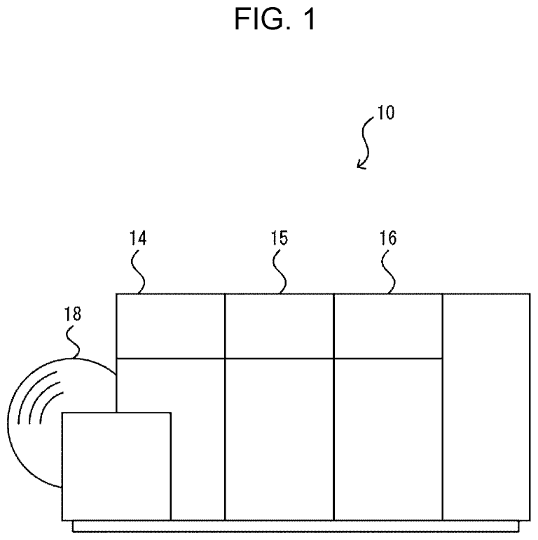

Hereinafter, an exemplary embodiment for implementing the technology of the present disclosure will be described in detail with reference to the drawings. FIG. 1 is a diagram of the external appearance of an image forming system 10 of an exemplary embodiment.

As illustrated in FIG. 1, the image forming system 10 includes a printer 14, an inspection device 15, and a disposal device 16.

The printer 14 is a continuous form printer that performs printing on a continuous sheet. Roll paper 18 as the continuous sheet is loaded onto the printer 14.

Any printing system such as a laser printing system or an inkjet system may be used as the printing system for the printer 14.

The inspection device 15 is a device for inspecting the quality of a printed material output from the printer 14. Specifically, the inspection device 15 evaluates the quality of the printed material by comparing a printing source image with a scanned image acquired by scanning the printed material output from the printer 14.

The disposal device 16 is a device for disposing of a printed material in which an anomaly is detected in the inspection device 15. In this exemplary embodiment, the disposal device 16 is, for example, a shredder.

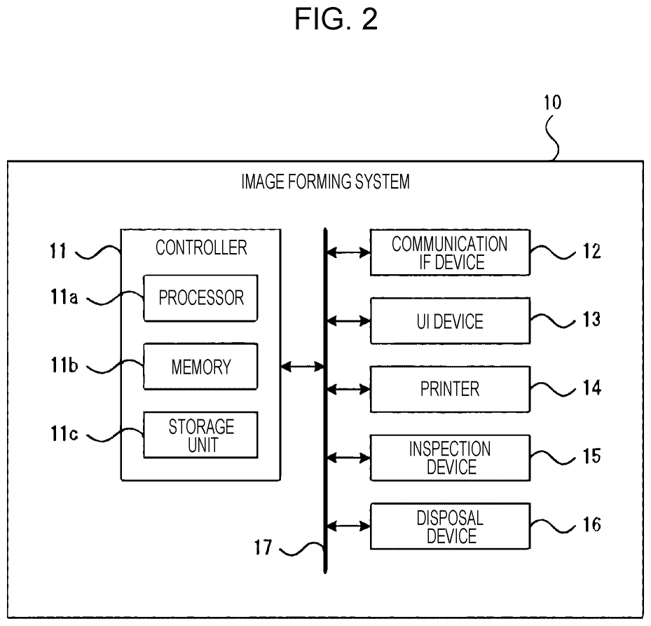

The hardware configuration of the image forming system 10 of this exemplary embodiment will then be described. FIG. 2 is a block diagram illustrating the hardware configuration of the image forming system 10.

As illustrated in FIG. 2, the image forming system 10 includes a controller 11, a communication interface (abbreviated as a communication IF) device 12, a user interface device (abbreviated as a UI device) 13, the printer 14, the inspection device 15, and the disposal device 16. These components are connected to each other via a control bus 17.

The controller 11 includes a processor 11a, a memory 11b, and a storage unit 11c. The processor 11a performs predetermined processing on the basis of a program read out from the storage unit 11c and loaded into the memory 11b. The storage unit 11c is composed of, for example, a ROM, a HDD, or a SSD. The storage unit 11c stores various programs, data, and the like.

In the description for this exemplary embodiment, the processor 11a reads out a program stored in the storage unit 11c and runs the program but is not limited to this. The program may be provided in such a manner as to be recorded in the computer readable recording medium as described above. The program may also be acquired from an external apparatus via a communication network.

The communication IF device 12 transmits and receives data to and from an external apparatus or the like. The UI device 13 is a device for a user to receive and input information, such as a touch panel and/or a button.

In an image forming system including a printer for a continuous form and an inspection device that inspects a printed material output from the printer, the printed material output from the printer is inspected by the inspection device and thereafter cut from a roll, and a printed material in which an anomaly is detected is discarded.

In this case, there is a possibility of leakage of information printed on the printed material, for example, because a worker sees or loses the printed material at the time of discarding the printed material.

To address the issue as described above, the controller 11 of the image forming system 10 of this exemplary embodiment causes the printed material output from the printer 14 to be transported to the inspection device 15. If an anomaly is detected in the printed material in the inspection device 15, the controller 11 causes the printer 14 to rewind the printed material with the detected anomaly, causes a leakage prevention process to be performed on the printed material in the printer 14, the leakage prevention process preventing information printed on the printed material from leaking to the outside, and causes the printed material on which the leakage prevention process is performed to be output again from the printer 14.

The leakage prevention process may be a concealing process in which a concealment image is printed on a printed part. The concealment image may be an image in which a processing area is filled out in a single color such as black. The concealment image may also be an image in which a geometrical pattern or a character string is disposed in a state where the content of the base of the processing area is not discriminable. The concealment image may be any image other than the above as long as the image is allowed to be in a state where the content of the base of the processing area is not discriminable.

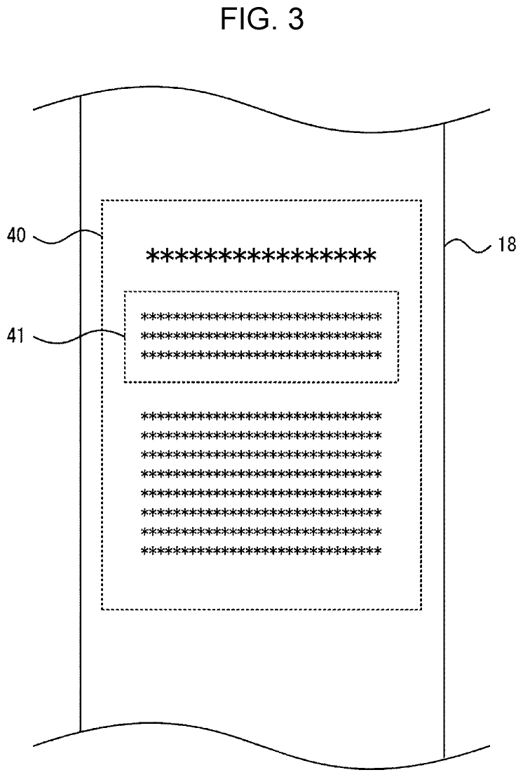

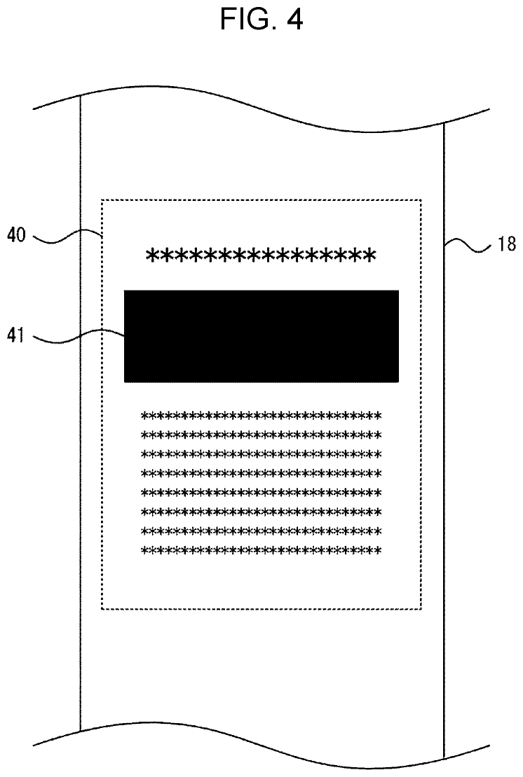

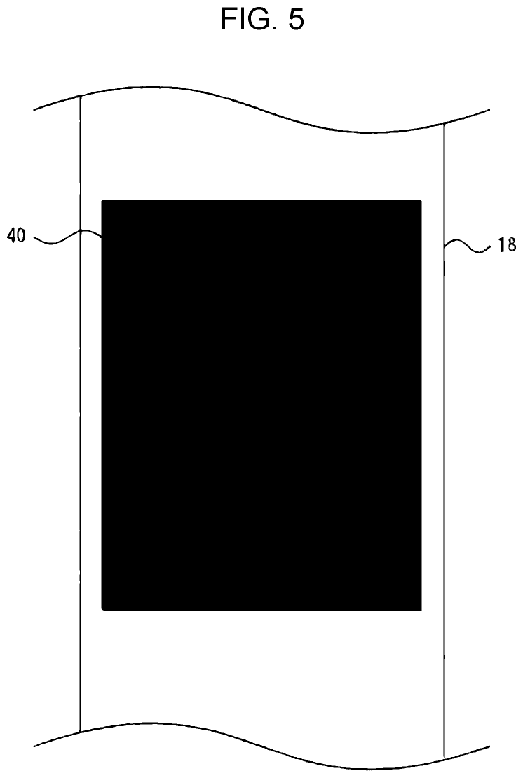

FIG. 3 illustrates an example printed material. As illustrated in FIG. 3, a concealment area 41 where information to be concealed is printed is present in a printing area 40 of a printed material. As illustrated in FIG. 4, the controller 11 may cause the printer 14 to execute the concealing process only in a concealment area 41 set in advance in the printed material. The controller 11 may also cause the printer 14 to execute the concealing process in the entirety of the printing area 40 of the printed material, as illustrated in FIG. 5.

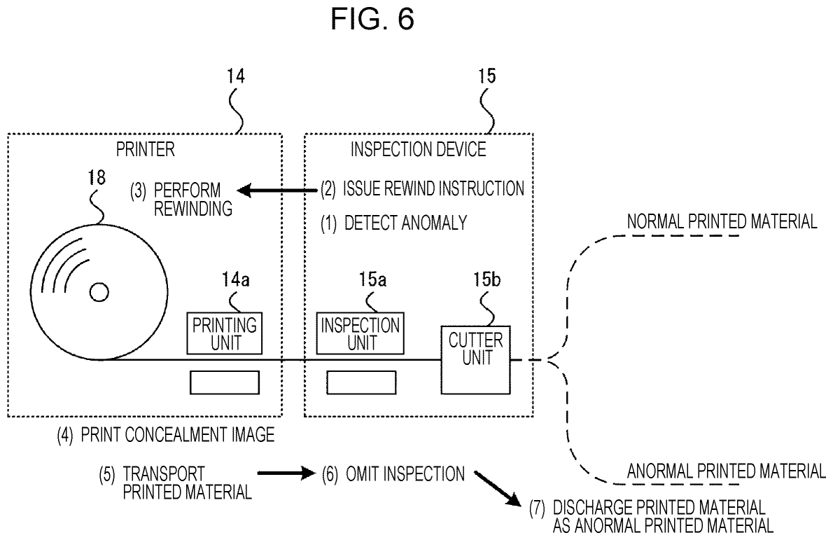

The processing flow of the concealing process serving as the leakage prevention process will then be described with reference to FIG. 6

The controller 11 causes the printed material printed in and output from a printing unit 14a of the printer 14 to be transported to the inspection device 15.

Subsequently, if a rewind instruction is issued in response to the detection of an anomaly in the printed material in an inspection unit 15a of the inspection device 15, the controller 11 causes the printer 14 to rewind the printed material with the detected anomaly.

Then the controller 11 causes the printing unit 14a of the printer 14 to print the concealment image on the printed material as the leakage prevention process and causes the printed material on which the concealment image is printed to be output again from the printer 14 and to be transported to the inspection device 15.

The controller 11 then causes the inspection unit 15a of the inspection device 15 to omit an inspection of the printed material output again and causes a cutter unit 15b to cut, from the roll paper 18, the printed material output again.

The controller 11 then causes the cut printed material to be discharged as an anormal printed material from the inspection device 15. The image forming system 10 may be configured to output the anormal printed material to the same discharging tray as that for a normal printed material or may be configured to a different discharging tray.

The leakage prevention process may also be an instruction-information printing process in which instruction information is printed, the instruction information being for instructing the inspection device 15 to transport the printed material with the detected anomaly to the disposal device 16.

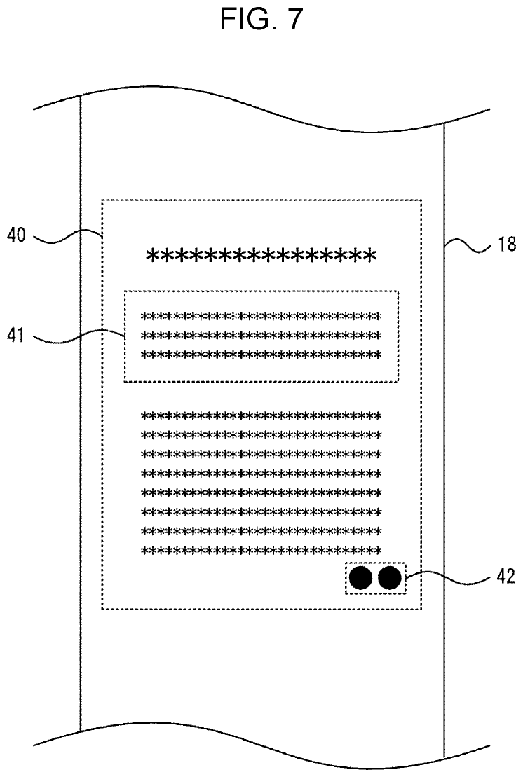

As illustrated in FIG. 7 as an example, a symbol 42 such as black circles is printed as the instruction information in a specific portion in the printing area 40 of the printed material. The instruction information is not limited to a symbol, and any information may be used as long as the information is identifiable in the inspection device 15, such as a character, a geometrical pattern, or a code image.

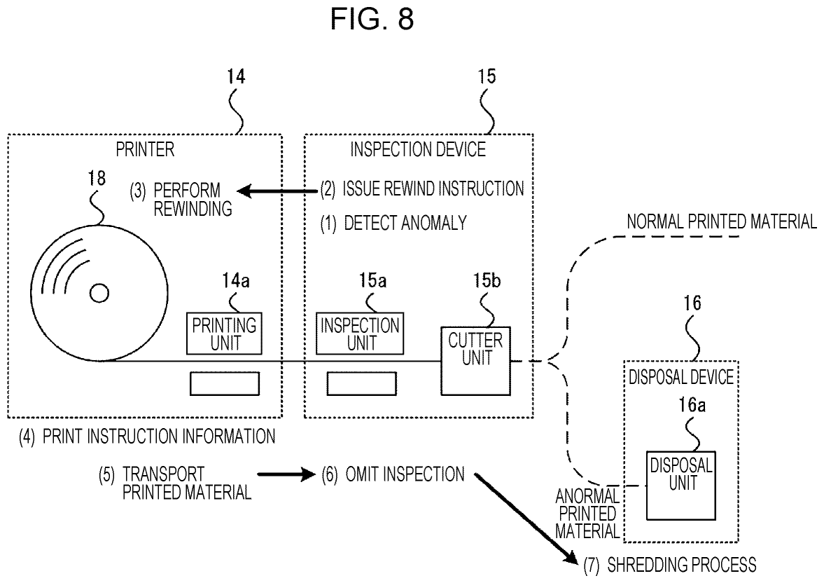

The processing flow of the instruction-information printing process serving as the leakage prevention process will then be described with reference to FIG. 8.

The controller 11 causes the printed material printed in and output from the printing unit 14a of the printer 14 to be transported to the inspection device 15.

Subsequently, if a rewind instruction is issued in response to the detection of an anomaly in the printed material in the inspection unit 15a of the inspection device 15, the controller 11 causes the printer 14 to rewind the printed material with the detected anomaly.

The controller 11 then causes the printing unit 14a of the printer 14 to print the instruction information on the printed material as the leakage prevention process and causes the printed material on which the instruction information is printed to be output again from the printer 14 and to be transported to the inspection device 15.

The controller 11 then causes the printed material output again to be read in the inspection unit 15a of the inspection device 15. If the symbol 42 serving as the instruction information is detected, the controller 11 causes the inspection of the printed material to be omitted, and causes the cutter unit 15b to cut, from the roll paper 18, the printed material output again.

The controller 11 then causes the cut printed material to be discharged as the anormal printed material from the inspection device 15 and to be transported to the disposal device 16.

The controller 11 then causes a disposal unit 16a of the disposal device 16 to execute a shredding process.

The leakage prevention process may also be a correction process in which the printed material with the detected anomaly is corrected to a normal printed material by performing reprinting on an anomaly detected portion of the printed material with the detected anomaly.

The correction process is performed if an anomaly is correctable by performing reprinting, for example, in a case of insufficient density in the printed material.

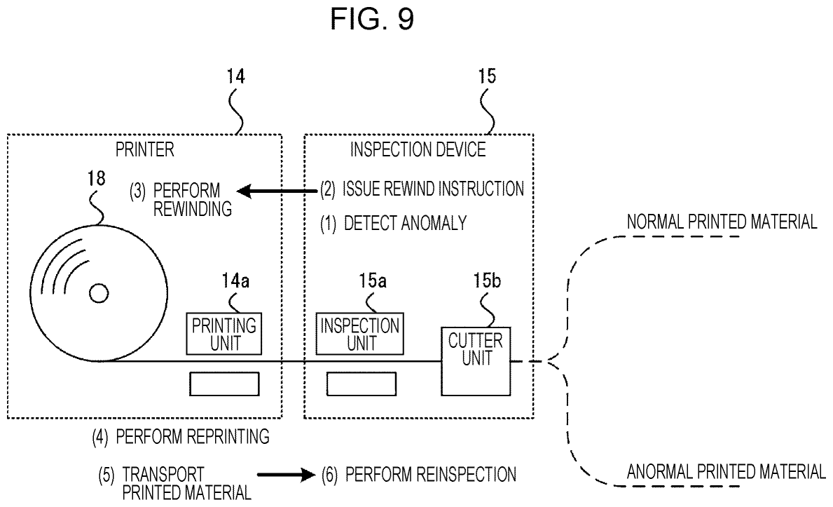

The processing flow of the correction process serving as the leakage prevention process will then be described with reference to FIG. 9.

The controller 11 causes the printed material printed in and output from the printing unit 14a of the printer 14 to be transported to the inspection device 15.

Subsequently, if a rewind instruction is issued in response to the detection of an anomaly in the printed material in the inspection unit 15a of the inspection device 15, the controller 11 causes the printer 14 to rewind the printed material with the detected anomaly.

The controller 11 then causes reprinting to be performed on the anomaly detected portion of the printed material as the leakage prevention process in the printing unit 14a of the printer 14 and causes the corrected printed material to be output again from the printer 14 and to be transported to the inspection device 15.

The controller 11 then reinspects the printed material corrected in the inspection unit 15a of the inspection device 15 for the printed material output again.

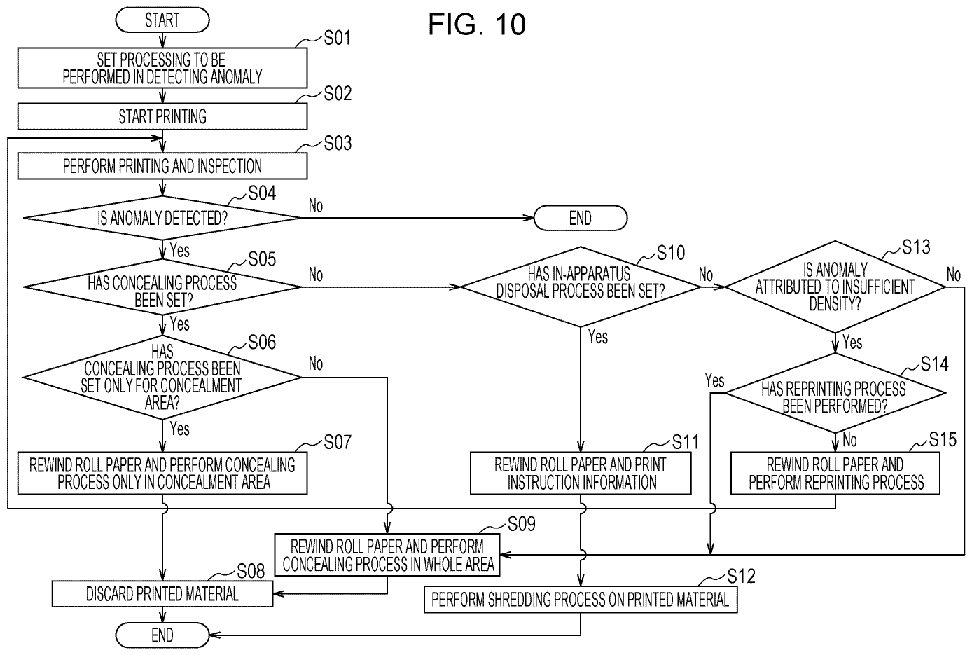

An inspection process for a printed material in the image forming system 10 of this exemplary embodiment will then be described with reference to a flowchart in FIG. 10.

First, in step S01, the controller 11 of the image forming system 10 sets the leakage prevention process to be performed in response to anomaly detection, in accordance with instruction input by the user. In this exemplary embodiment, one of the concealing process, the instruction-information printing process (hereinafter, referred to as an in-apparatus disposal process), and the correction process that are described above is set as the leakage prevention process.

In step S02, the controller 11 then starts printing. In step S03, the controller 11 then performs printing and inspection. In step S04, the controller 11 determines whether an anomaly is detected in the printed material.

If it is not determined in step S04 that an anomaly is detected in the printed material, the controller 11 terminates the processing.

If it is determined in step S04 that an anomaly is detected in the printed material, the controller 11 determines, in step S05, whether the concealing process is set as the leakage prevention process.

If it is determined in step S05 that the concealing process is set as the leakage prevention process, the controller 11 determines, in step S06, whether the concealing process only for a concealment area is set.

If it is determined in step S06 that the concealing process only for a concealment area is set, the controller 11 rewinds the roll paper 18 and performs the concealing process only in the concealment area in step S07.

In step S08, the controller 11 then discharges the printed material to the outside of the image forming system 10 to be discarded and terminates the processing.

If it is not determined in step S06 that the concealing process only for a concealment area is set, the controller 11 rewinds the roll paper 18 and performs the concealing process in the whole printing area in step S09.

In step S08, the controller 11 then discharges the printed material to the outside of the image forming system 10 to be discarded and terminates the processing.

If it is not determined in step S05 that the concealing process is set as the leakage prevention process, the controller 11 determines, in step S10, whether the in-apparatus disposal process is set as the leakage prevention process.

If it is determined in step S10 that the in-apparatus disposal process is set as the leakage prevention process, the controller 11 rewinds the roll paper 18 and prints the instruction information on the printed material with the detected anomaly in step S11.

In step S12, the controller 11 then transports the printed material to the disposal device 16 via the inspection device 15, performs the shredding process, and terminates the processing.

If it is not determined in step S10 that the in-apparatus disposal process is set as the leakage prevention process, the controller 11 determines, in step S13, whether the anomaly in the printed material is attributed to insufficient density.

If it is not determined in step S13 that the anomaly in the printed material is attributed to insufficient density, the controller 11 moves to step S09.

If it is determined in step S13 that the anomaly in the printed material is attributed to insufficient density, the controller 11 determines, in step S14, whether a reprinting process has been performed on the printed material. The determination of whether the reprinting process has been performed on the printed material may be performed in any manner, for example, in such a manner as to be performed with reference to a device operation history.

If it is determined in step S14 that the reprinting process has been performed on the printed material, the controller 11 moves to step S09.

If it is not determined in step S14 that the reprinting process has been performed on the printed material, the controller 11, in step S15, rewinds the roll paper 18, performs the reprinting process on the printed material, and moves to step S03.

### Modification

The image forming system of an exemplary embodiment of the present disclosure has heretofore been described. The technology of the present disclosure is not limited to the exemplary embodiment above and may be changed appropriately.

In the exemplary embodiments, the term “processor” refers to hardware in a broad sense, and the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU).

Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

The system in the technology of the present disclosure includes both of a system including multiple apparatuses and a system including a single apparatus.

The technology of the present disclosure is applicable to a program and a program product.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An image forming system includes:
a printer for a continuous form;
an inspection device that inspects a printed material output from the printer; and
a processor configured to:
   cause a printed material output from the printer to be transported to the inspection device;
   in response to an anomaly being detected in the printed material in the inspection device, cause the printer to rewind the printed material with the detected anomaly;
   cause a leakage prevention process to be performed on the printed material in the printer, the leakage prevention process preventing information printed on the printed material from leaking outside; and
   cause the printed material on which the leakage prevention process is performed to be output again from the printer.
      (((2)))

In the image forming system according to (((1))),
the leakage prevention process is a concealing process in which a concealment image is printed on a printed part.
   (((3)))

In the image forming system according to (((2))),
the processor is configured to cause the printer to perform the concealing process only in an area set in advance in the printed material.
   (((4)))

The image forming system according to (((1))) further includes:
a disposal device that disposes of a printed material at a stage subsequent to the inspection device, and
the leakage prevention process is an instruction-information printing process in which instruction information is printed, the instruction information being for instructing the inspection device to transport the printed material with the detected anomaly to the disposal device.
   (((5)))

In the image forming system according to (((4))),
the disposal device is a shredder.
   (((6)))

In the image forming system according to (((1))),
the leakage prevention process is a correction process in which the printed material with the detected anomaly is corrected to a normal printed material by performing reprinting on an anomaly detected portion of the printed material with the detected anomaly.
   (((7)))

A program causes a computer to execute a process including:
causing a printed material output from a printer for a continuous form to be transported to an inspection device;
in response to an anomaly being detected in the printed material in the inspection device, causing the printer to rewind the printed material with the detected anomaly;
causing a leakage prevention process to be performed on the printed material in the printer, the leakage prevention process preventing information printed on the printed material from leaking outside; and
causing the printed material on which the leakage prevention process is performed to be output again from the printer.

What is claimed is:

1. An image forming system comprising:
a printer for a continuous form;
an inspection device that inspects a printed material output from the printer; and
a processor configured to:
cause a printed material output from the printer to be transported to the inspection device;
in response to an anomaly being detected in the printed material in the inspection device, cause the printer to rewind the printed material with the detected anomaly;
cause a leakage prevention process to be performed on the printed material in the printer, the leakage prevention process preventing information printed on the printed material from leaking outside; and
cause the printed material on which the leakage prevention process is performed to be output again from the printer.

2. The image forming system according to claim 1,
wherein the leakage prevention process is a concealing process in which a concealment image is printed on a printed part.

3. The image forming system according to claim 2,
wherein the processor is configured to cause the printer to perform the concealing process only in an area set in advance in the printed material.

4. The image forming system according to claim 1, further comprising:
a disposal device that disposes of a printed material at a stage subsequent to the inspection device,
wherein the leakage prevention process is an instruction-information printing process in which instruction information is printed, the instruction information being for instructing the inspection device to transport the printed material with the detected anomaly to the disposal device.

5. The image forming system according to claim 4,
wherein the disposal device is a shredder.

6. The image forming system according to claim 1,
wherein the leakage prevention process is a correction process in which the printed material with the detected anomaly is corrected to a normal printed material by performing reprinting on an anomaly detected portion of the printed material with the detected anomaly.

7. A non-transitory computer readable medium storing a program causing a computer to execute a process comprising:
causing a printed material output from a printer for a continuous form to be transported to an inspection device;
in response to an anomaly being detected in the printed material in the inspection device, causing the printer to rewind the printed material with the detected anomaly;
causing a leakage prevention process to be performed on the printed material in the printer, the leakage prevention process preventing information printed on the printed material from leaking outside; and
causing the printed material on which the leakage prevention process is performed to be output again from the printer.

8. An image forming method comprising:
causing a printed material output from a printer for a continuous form to be transported to an inspection device;
in response to an anomaly being detected in the printed material in the inspection device, causing the printer to rewind the printed material with the detected anomaly;
causing a leakage prevention process to be performed on the printed material in the printer, the leakage prevention process preventing information printed on the printed material from leaking outside; and
causing the printed material on which the leakage prevention process is performed to be output again from the printer.
